(19) United States
(12) Patent Application Publication
(10) Pub. No.: US 2006/0159846 A1
(43) Pub. Date: Jul. 20, 2006

(54) Particle coating method

(76) Inventors: Emmanuel Rodrigues, Bischwiler (FR); Dominique Roche-Lagarde, Obernai (FR)

Correspondence Address: FITZPATRICK CELLA HARPER & SCINTO, 30 ROCKEFELLER PLAZA, NEW YORK, NY, 10112, US

(21) Appl. No.: 10/239,128

(22) PCT Filed: Mar. 21, 2001
(86) PCT No.: PCT/FR01/00838

§ 371 Date: Nov. 13, 2003

(30) Foreign Application Priority Data
Mar. 21, 2000 (FR) 00/03612

(51) Int. Cl. B05D 7/00; B05D 3/02; A23G 3/26; B05C 3/00

(52) U.S. Cl. 427/212; 427/372.2; 118/13; 118/58; 118/63; 118/19; 118/29

(57) ABSTRACT

A method for coating edible particles in a rotary chamber which includes the steps of contacting the particles with a coating solution, then contacting the particles with drying air. The drying air includes at least 3.8 grams of water per kilogram of air.

### TECHNICAL FIELD

The invention relates to apparatus and methods of coating particles, especially for manufacturing confectionery.

### BACKGROUND OF THE INVENTION

Confectionery in the form of granules is known, comprising a center (peanut, chocolate, etc.) and coated with successive hard layers of sugar. These layers are put in place by spraying a sugar syrup onto the centers placed in a rotating chamber. Next, a flow of air inside the chamber makes it possible to dry the sugar layer coating each center. The successive layers are put in place by multiplying the number of spraying drying cycles.

However, in order to obtain proper drying, the known methods require relatively high product temperatures such that some heat-sensitive centers prove to be awkward to coat properly. So that they have an acceptable appearance at the end of manufacture, especially in terms of color and brightness, the drying cycles must be quite long. For other products which withstand heat better, the flow rate of drying air, at an identical temperature, is too high.

### BRIEF SUMMARY OF THE INVENTION

One aim of the invention is to provide a more efficient coating method.

For the purpose of achieving this aim, provision is made according to the invention for a method of coating edible particles in which, in a moving chamber: the particles are placed in contact with a coating solution, then, the particles are placed in contact with the drying air, in which the drying air comprises less than 3.8 g of water per kilogram of air.

Thus, the drying operation is optimized by the use of drier air having, for example, a dew point generally below 0° C.

The dew point and the blown air temperature condition the temperature in the product bed during drying: the lower this dew point, the lower the temperature in the product bed, which makes it possible to maintain the quality of heat-sensitive products, such as for example chocolate beans. For example, by going from a dew point of +5° C. to a dew point of −15° C., it is possible to lower the temperature of the product bed by about 4° C., which makes it possible to preserve the quality of heat-sensitive products.

With air having a low dew point, it will also be possible to increase the temperature of the blown air even for a heat-sensitive product and therefore to have more efficient drying, or to keep the same drying efficiency but to decrease the volumes of blown air.

Reducing the volumes of air required for the process therefore makes it possible to very substantially decrease the size of the air treatment stations, therefore to decrease the investment burden, to simplify the workshops and also to save some energy.

Thus, by keeping the same blown air temperatures, it was possible to halve the volumes of air required for the drying process. By combining the use of dry air and the increase in the temperature of the blown air, it is possible to reduce the volumes of air required even further.

Finally, the use of air with a low dew point provides much better drying control, better stability of the process and hence improved and more constant product quality.

Furthermore, the method according to the invention may have at least one of the following characteristics:
the drying air comprises less than 3.5 g of water per kilogram of air;
the drying air comprises less than 2.5 g of water per kilogram of air;
the drying air comprises less than 20 g of water per kilogram of air;
the drying air comprises less than 1 g of water per kilogram of air;
the drying air has a dew point less than −15° C.;
the drying air has a temperature between 15 and 85° C.;
the drying air has a temperature between 20 and 40° C.;
the coating solution comprises at least one sugar;
the coating solution comprises sucrose;
the coating solution comprises a sugar substitute compound;
the coating solution comprises a polyol and/or sugar alcohol compound.

According to the invention, provision is also made for an apparatus for coating edible particles, comprising:
a chamber capable of being made to move;
means for bringing a coating solution into contact with the particles contained in the chamber; and
drying means for bringing the drying air into contact with the particles in the chamber,
in which the drying means are capable of bringing the air comprising less than 3.8 g of water per kilogram of air into contact with the particles.

Advantageously the drying means are capable of bringing the air comprising less than 3.5 g of water per kilogram of air into contact with the particles.

Advantageously the drying means are capable of bringing the air comprising less than 2.5 g of water per kilogram of air into contact with the particles.

Advantageously the drying means are capable of bringing the air comprising less than 2 g of water per kilogram of air into contact with the particles.

Advantageously the drying means are capable of bringing the air comprising less than 1 g of water per kilogram of air into contact with the particles.

Advantageously the chamber is mounted so that it can rotate about an axis, the apparatus comprising an air circulation duct having a body and an end part perforated with orifices capable of extending over the low part of the chamber.

Coating apparatus comprising a tube with such an end part perforated with orifices are known.

Furthermore, for the purpose of improving the drying efficiency, provision is made according to a first preferred embodiment of the invention for the end part to be a shoe having, in a plane perpendicular to a direction radial to the axis, a cross section which is greater than the cross section of the body.

Thus, this end part provides considerable dispersion of the drying air within the particles. Furthermore, during this dispersion, it provides considerable agitation of the particles. By virtue of its large area for exchange with the particles, this end part continuously dries a large number of particles, which improves the uniformity of the drying.

Furthermore, the apparatus may have at least one of the following characteristics:
the shoe has a width parallel to the axis, which is greater than the width of the body;
the shoe has a length in a plane perpendicular to the axis and substantially perpendicular to the radial direction, which is greater than the length of the body;
the body is closer to the rear of the shoe than to the front, with reference to a normal direction of rotation of the chamber;
the shoe has a width, parallel to the axis; narrowing toward the front from the body with reference to a normal direction of rotation of the chamber;
the shoe has a width, parallel to the axis, narrowing in the direction of the body, from a region of greater width;
the shoe has a width, parallel to the axis, narrowing in the direction away from the body, from a region of greater width;
the duct has a front flange lying generally in a radial plane from the shoe to the body;
the shoe has the overall shape of a disk, the plane containing the diameter of which is perpendicular to the axis of the body;
the diameter of the disk is greater than the diameter of the body;
the shoe has the overall shape of a crescent;
the virtual axis connecting the two tips of the crescent extend in parallel with reference to the normal axis of rotation of the chamber and is coincident with a radial plane of the tube;
the tips of the crescent are curved in the direction of the body;
the chamber comprises a peripheral wall, two end walls, and at least one deflector extending from the peripheral wall.

Coating chambers fitted with such a deflector are known. This type of deflector is intended to promote agitation of the particles in order to produce uniform coating and drying thereof. However, the known deflectors, often lying in a plane radial to the axis of rotation of the chamber, are difficult to clean.

Another aim of the invention is to provide a chamber which is easier to clean.

For the purpose of achieving this aim, provision is further made for the or each deflector to have a shape perpendicular, at least locally, to a direction radial to the axis.

Furthermore, the invention may have at least one of the following characteristics:
the or each deflector is flat;
the or each deflector is contiguous with only one of the end walls;
the or each deflector extends from a point of the peripheral wall away from one of the end walls, to another point of the other end wall away from the peripheral wall;
the apparatus comprises at least two deflectors;
the two deflectors are flat and parallel;
the peripheral wall is cylindrical;
at least one inner face of the chamber is covered with elastomer;
the particles are food particles;
the particles are items of confectionery.

In this case, the particles in question could be intended to form part of ingestible elements. It could involve food granules for humans or animals. It could especially involve confectionery. The invention is also applicable to coating pharmaceutical compositions.

### BRIEF DESCRIPTION OF THE DRAWINGS

Still other advantages and characteristics of the invention will become apparent from the following description of a preferred embodiment given by way of nonlimiting example. In the appended drawings:

FIG. 1 is a view in axial section of a coating apparatus according to the invention;

FIG. 2 is a left-hand view of the apparatus of FIG. 1 in cross section;

FIGS. 3, 4 and 5 are face, left and top views of the shoe of the apparatus of FIG. 1;

FIG. 6 is a view similar to FIG. 1 showing the deflectors;

FIG. 7 is a top view of the apparatus of FIG. 6;

FIG. 8 is a perspective view of a second embodiment of the shoe for the apparatus;

FIG. 9 is a perspective view of a third embodiment of the shoe of the apparatus;

FIG. 10 is a representation in perspective of another exemplary embodiment of the chamber of the apparatus; and

FIG. 11 is a representation in section and in perspective of the embodiment of FIG. 10.

### DETAILED DESCRIPTION OF THE INVENTION

In the present example, the method according to the invention is applied to the manufacture of confectionery. It involves granules of the M&M's® type comprising a center coated with hard layers of sugar syrups. In order to provide this coating, the centers are placed in a rotating chamber, the syrup is sprayed onto the centers, then air is made to flow within the particle bed in order to dry the syrup coating the centers. According to the invention, this air is particularly dry. It has less than 3.8 g of water per kilogram of air. Preferably it has between 0.5 and 1 g of water per kilogram of air, which provides it with a relative humidity of less than 5% at a temperature of 20° C. and a dew point of less than −15° C. With such drying air, the temperature of the particle bed can be lowered, especially if the particles are sensitive to heat.

The amount of moisture in the drying air will advantageously be less than 2.5 g of water per kilogram of air and preferably less than 1.5 g, or even less than 1 g. The flow of drying air will advantageously be between 1 and 10 m³/h per kg of dry product.

Prior to its introduction into the chamber, the air will undergo a treatment to dry it, preferably by chemical means. This will involve, for example, treatment by bubbling though a lithium-chloride-based liquid phase, as proposed by KATHABAR or else treatment by contact with a silica-gel-based solid phase, as proposed by MUNTERS. Such treatments are known per se and will not be described here.

An apparatus for implementing the method according to the invention will now be described.

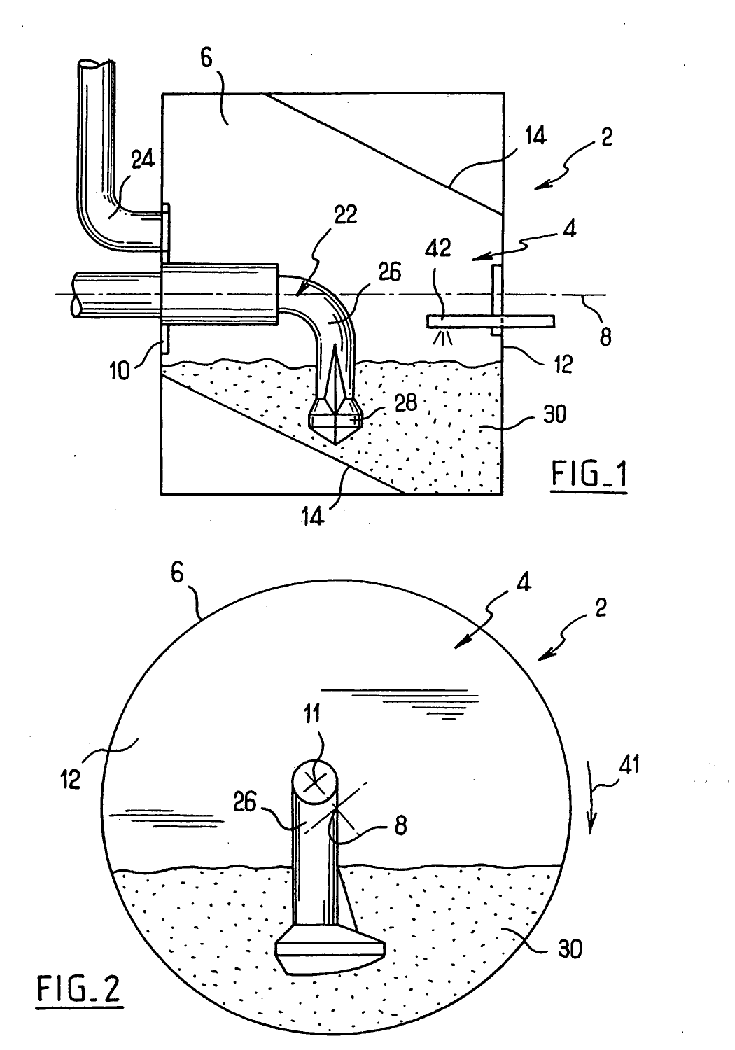

With reference to FIGS. 1 and 2, the apparatus 2 comprises a drum or chamber 4 having a cylindrical peripheral wall 6 with an axis 8 and two, left and right, end walls 10, 12 in the overall shape of a flat disk. The chamber is mounted so that it can rotate about its axis 8 and is driven in rotation by suitable motorized means. It comprises a duct for introducing centers to be coated into the chamber and an opening for removing the coated particles, which have not been illustrated.

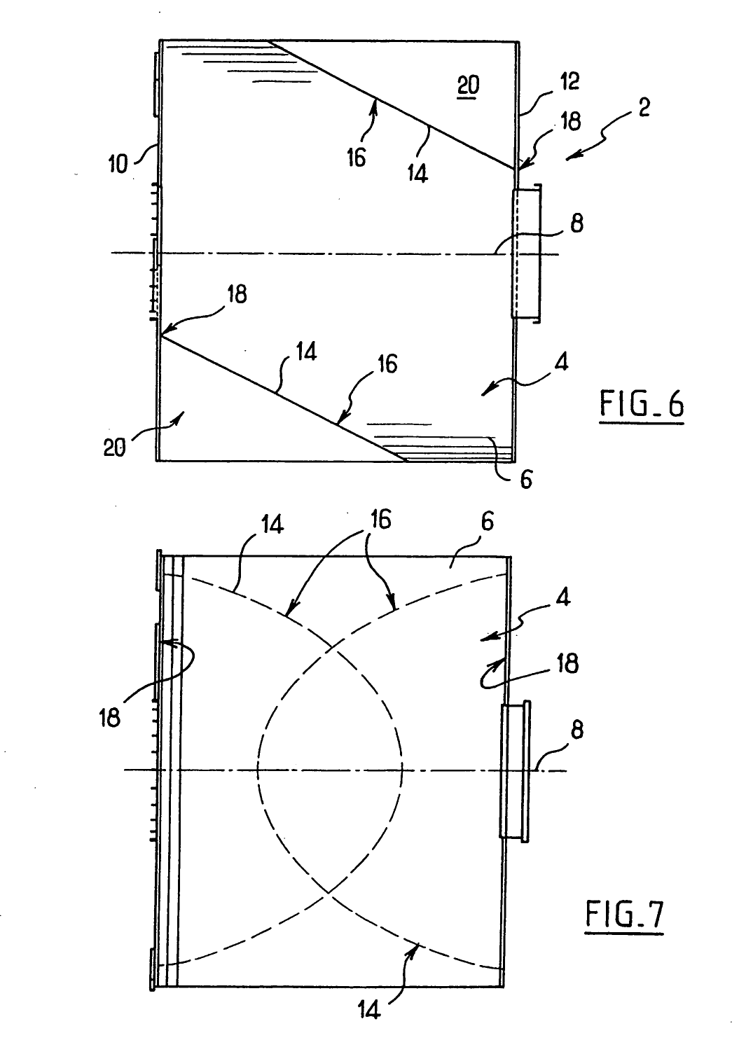

With reference to FIGS. 6 and 7, the chamber comprises deflectors 14, in this case there are two of them and they are identical. Each deflector 14 is flat. It is limited on one side by an elliptical arc-shaped edge 16 and on the other by a straight edge 18 perpendicular to the major axis of the ellipse. Each deflector is joined by its straight edge 18 to a respective straight edge of the end walls 10, 12. The straight edge is at some distance from the cylindrical wall 6, except at its two ends, which are located at the junction of the cylindrical wall 6 and the end wall. The elliptical arc-shaped edge is joined to the cylindrical wall 6 and at some distance from the other end wall.

In profile, as in FIG. 6, each deflector 14 is inclined with respect to the axis 8 and to the generatrix of the cylinder. It is inclined in the direction of the end wall to which it is not joined. The two deflectors are parallel to each other. Each deflector isolates and closes off a region 20 of the chamber from the rest of the chamber. The particles cannot access these two regions. The two deflectors 14 provide considerable agitation of the particles from left to right and from right to left during the coating and drying when the chamber is rotating.

In this case, the chamber will be free of orifices or perforations on the cylindrical wall, the end walls and the deflectors being intended to allow liquids and gases through while retaining the particles. However, the chamber could alternatively comprise such perforations.

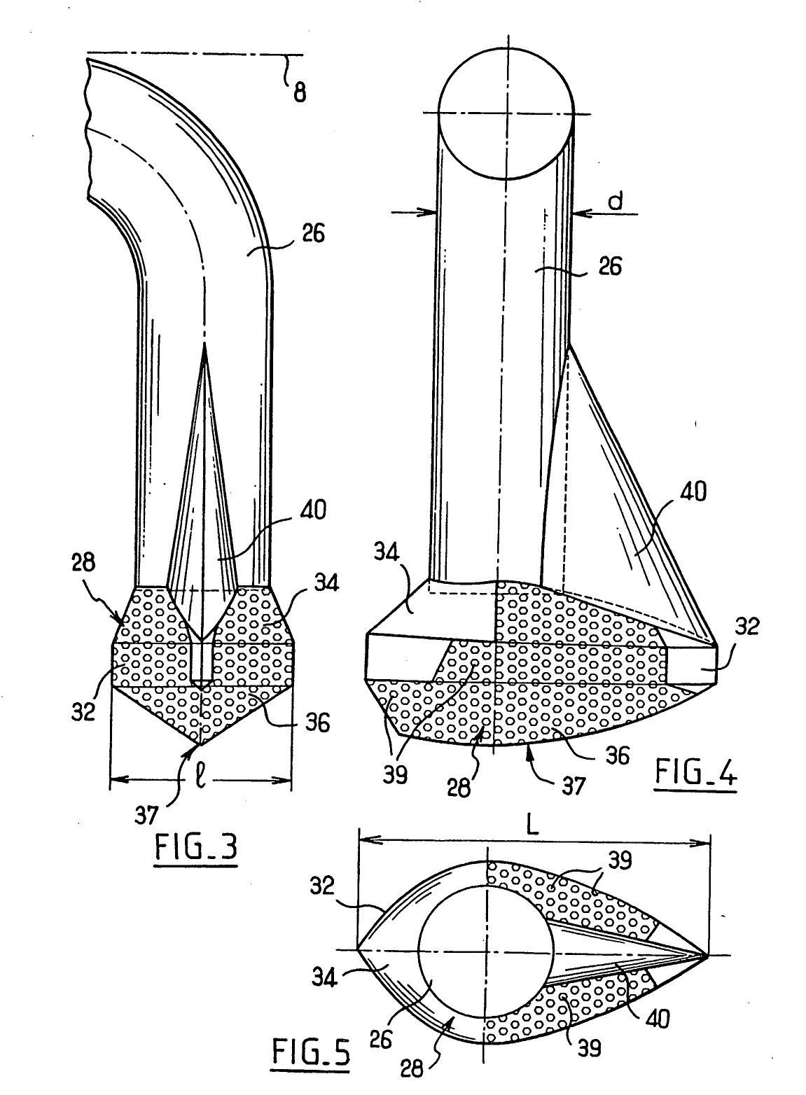

With reference to FIGS. 1 and 3, the apparatus comprises an air inlet duct 22 and an air outlet, for example in the form of a grille or a duct 24. The chamber is constructed with connection means capable of turning while these ducts remain fixed. The duct 22 comprises an inner tube bent at the body 26 having an end part or shoe 28 capable of lying in the lower half of the chamber, within the particle bed 30. The bent inner duct 26 is able to rotate about an axis 11 parallel to the axis 8 so that it can be raised into the upper part of the chamber by rotating the shoe. Above the shoe, the tube 26 has a cylindrical shape.

A preferred shape of the shoe 28 will now be described. With reference to FIGS. 3, 4 and 5, the shoe has a central region 32 with vertical faces. This central region 32 is the largest cross section of the shoe in a plane perpendicular to a direction substantially radial to the axis and this cross section is greater than the corresponding cross section on the tube 26. Thus, the length L of the central region 32, in a plane perpendicular to the axis 8 and substantially perpendicular to the radial direction, is greater than the diameter d of the tube 26. Similarly, the width l of the central region 32, parallel to the axis 8 is greater than the diameter d. Furthermore, the length L is in this case equal to about twice the width l. The shoe 28 has an upper region 34 forming the junction between the central region 32 and the tube 26. This region 34 flares from the tube to the central region. Similarly, it has a lower region 36 which shrinks toward the bottom and forms a ridge 37 parallel to the length L. Furthermore, the tube comprises a front flange 40 extending from the upper region 34 to the tube 26. This flange lies in an essentially radial plane and has a triangular shape. A rear vertical edge of the flange runs alongside the tube 26, another lower edge runs alongside the upper region 34. The shoe has an overall shape which is flattened in the radial direction, that is to say widened perpendicular to this direction.

Other shapes of shoes 28 can be envisioned.

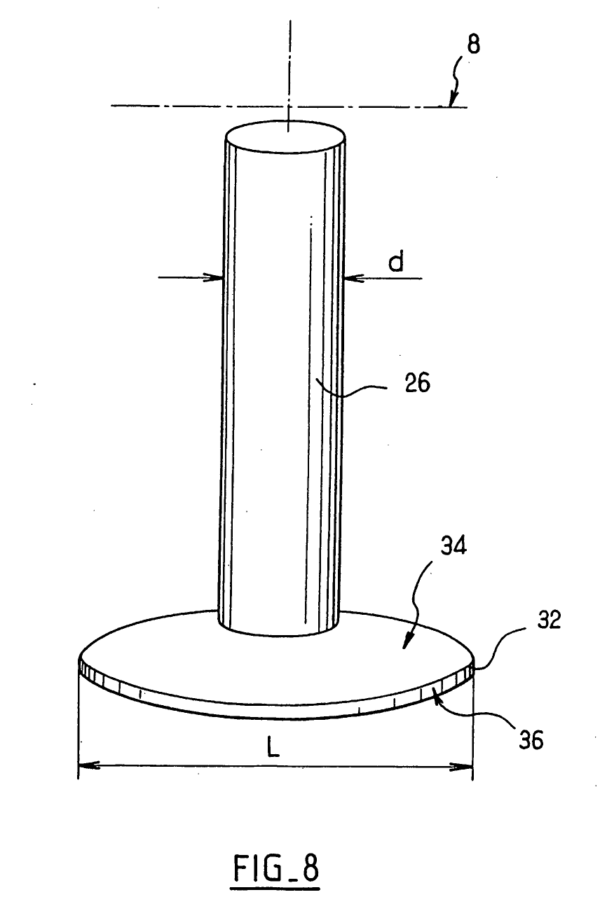

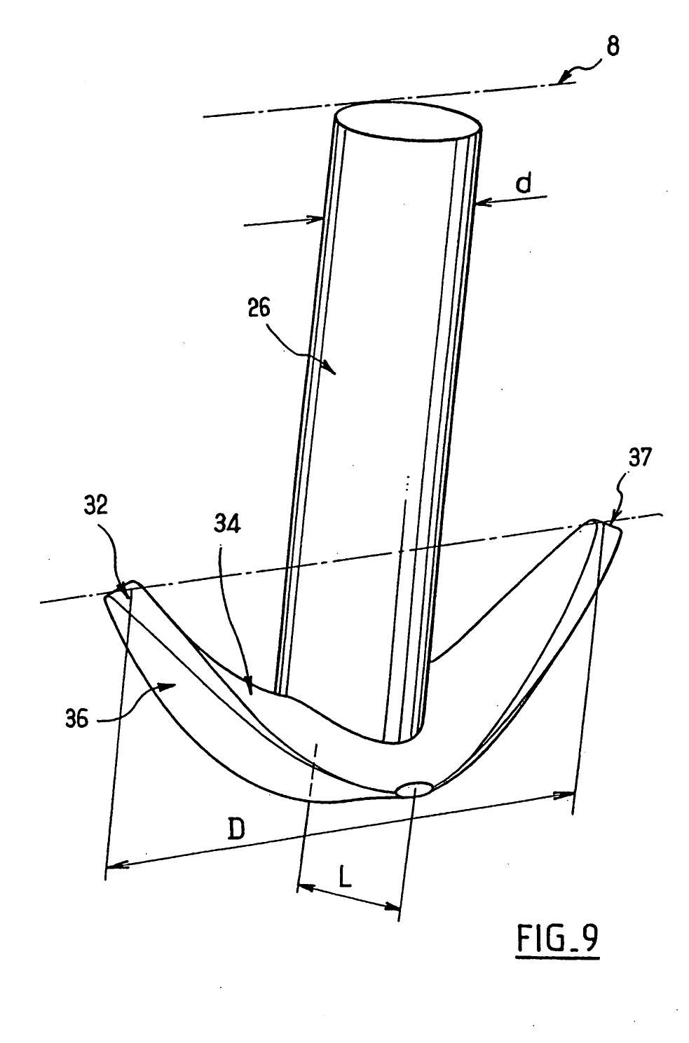

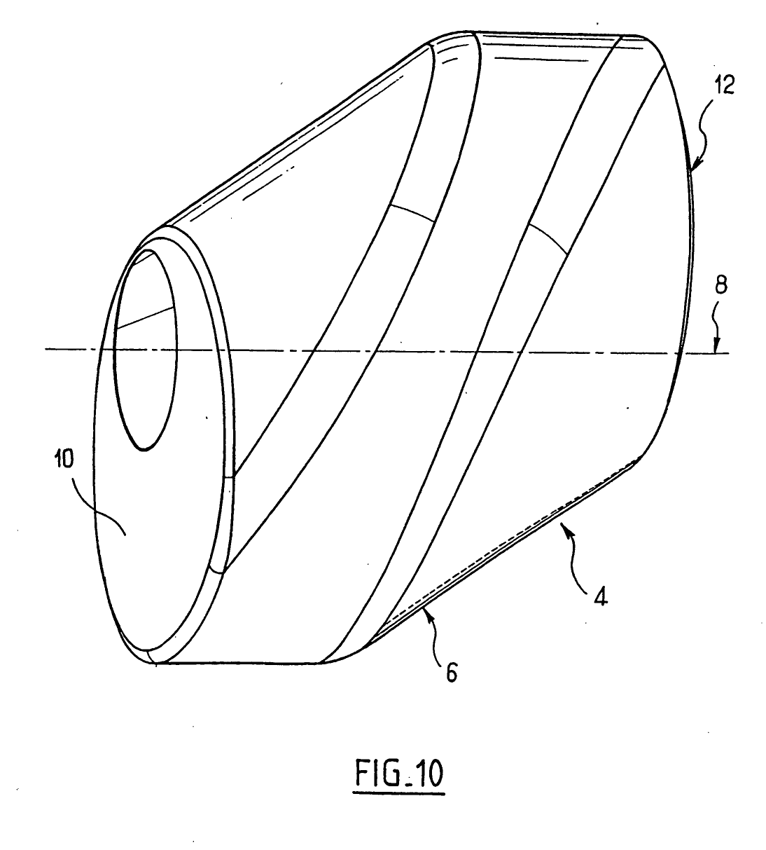

In a second embodiment, the shoe 28 will have an overall disk shape. With reference to FIG. 8, the shoe has a central region 32, with the largest cross section of the shoe, in a plane perpendicular to a direction which is substantially radial to the axis 8. This cross section is greater than the cross section of the tube 26. Thus, the length L of the central region 32, in a plane parallel to the axis 8, is greater than the diameter d of the tube 26. Furthermore, the length L is in this case equal to about four times the width d. The shoe 28 has an upper region 34 forming the junction between the central region 32 and the tube 26. This region 34 flares, with for example an ovoid curvature, from the tube to the central region. Similarly, it has a lower region 36, narrowing down from the region 32 to the lower end of shoe with, for example, the same ovoid curvature. The shoe has an overall shape which is flattened in a direction perpendicular to the radial direction, that is to say, widened parallel to the axis 8.

In a third embodiment, the shoe 28 will have the overall shape of a crescent. With reference to FIG. 9, the shoe has a central region 32. The general profile of the region 32 in a radial direction is in the shape of a parabola turned toward the tube 26. The plane containing the profile of the parabola contains the axis of the tube 26. The length L of the central region 32, in a plane perpendicular to the axis 8 and substantially located at right angles to the junction (tube 26-shoe 28), is greater than the diameter d of the tube 26. Similarly, the width D of the central region 32 at right angles to the tips of the crescent, parallel to the axis 8, is greater than the diameter d. Furthermore, the length D is in this case equal to about three times the width L.

The shoe 28 has an upper region 34 forming the junction between the central region 32 and the tube 26. This region 34 flares and curves back from the tube up to the central region. Similarly, the length of the region 34 in a series of planes perpendicular to the axis 8 shrinks from the junction region (shoe 28-body 26) to the tips of the crescent turned toward the tube 26. Furthermore, the tube 28 has a lower region 36 narrowing down from the region 32 to the lower end of the shoe. The virtual axis 37 connecting the two tips of the crescent preferably lies parallel to the normal axis of rotation of the chamber and falls within a radial plane of the tube 26.

The operation of the three embodiments of the shoe is similar.

The inside of the shoe 28 communicates with the tube 26. The shoe is perforated with orifices 39 on its central 32, upper 34 and lower 36 regions, except at the front parts of these three regions and except at the rear parts of the upper and central regions. The shoe thus forms a large area for exchange with the particle bed 30 in which it is submerged. The shoe is placed such that it lies always at some distance from the deflectors 14 and midway between the end walls 10, 12.

In this instance, the orifices have a diameter of 7 mm and a difference between axes of 8.5 mm. The exchange surface area of the shoe extends over 0.2357 m² with 45% void. The speed of the air through the orifices is 11 m/s.

The apparatus comprises known means 42, especially a nozzle means, for introducing a coating syrup, in this case based on sugar, into the chamber and spraying it.

When the method is implemented, the centers 30 to be coated are introduced into the rotating chamber 4, then the coating syrup is sprayed onto the moving centers. Next, the spraying is interrupted and dry air is injected into the bed of coated centers by means of the shoe 28. The moisture-laden air is removed via the duct 24. During rotation, the two deflectors 14 agitate the particles from left to right and from right to left. The shoe 28 injects drying air into the particle bed. This air passes through the bed to be removed via the duct 24. When drying is complete a new coating cycle is started and so on until a hard layer of the desired thickness is obtained.

Advantageously, the external faces of the shoe 28 and of the deflectors 14 and the internal faces of the chamber 4, that is to say all the faces intended to be in contact with the particles, can be coated with food-grade rubber so as to limit the risk of damage to these faces during coating, by knocks and impacts, to a minimum.

The invention could be implemented, for example, as follows.

The centers are peanuts coated with chocolate and sugar. Furthermore, the coating makes it possible to produce a crisp, colored and bright sugar shell. In the finished product, the percentages by mass are:

| | |
|---|---|
| peanut: | 24% |
| chocolate: | 48% |
| sugar coating: | 28% |

The syrup has the following compositions by mass:

| | |
|---|---|
| sugar solution (74% sugar, 26% water): | 91.5% |
| water: | 1.4% |

To treat 1048 kg of centers, thirty syrup applications, each of 7.2 liters, are performed, with drying lasting from 6 to 15 minutes each time, depending on the appearance that the granules are to be given.

The drying air is blown at a temperature of 23.5° C. It contains 1 g of water/kg of air and has a dew point of −15° C.

The flow rate is 3400 m³/h for the twelve applications. This flow rate corresponds to a quantity of air of 9.4 m³/h/m² of surface area of the centers to be coated. In general, provision can be made for the flow rate to be between 1 and 24 m³/h/m² of surface area of the centers to be coated, advantageously between 4 and 15 m³/h/m² and preferably between 7 and 12 m³/h/m² of surface area of the centers to be coated.

Of course, numerous modifications may be made to the invention without departing from the scope thereof.

The shoe 28 can be implemented independently of the use of particularly dry drying air or of the deflectors 14 described above.

Thus, it is possible to envision a particle-coating apparatus 2 comprising a chamber 4 mounted so as to rotate about an axis 8 and an air circulation tube 22 having a body 26 and an end part 28 perforated with orifices 39 capable of extending into the lower part of the chamber, in which, in a plane essentially perpendicular to a direction radial to the axis, the end part has a larger cross section than the cross section of the body.

Likewise, the deflectors 14 can be implemented independently of the shoe 28 and of the dry air.

Thus, it is possible to envision a particle-coating chamber 2 mounted so as to rotate about an axis 8, and comprising:
a peripheral wall 6;
two end walls 10, 12; and
at least one deflector 14 extending from the peripheral wall, in which the or each deflector has a shape locally perpendicular to a plane radial to the axis.

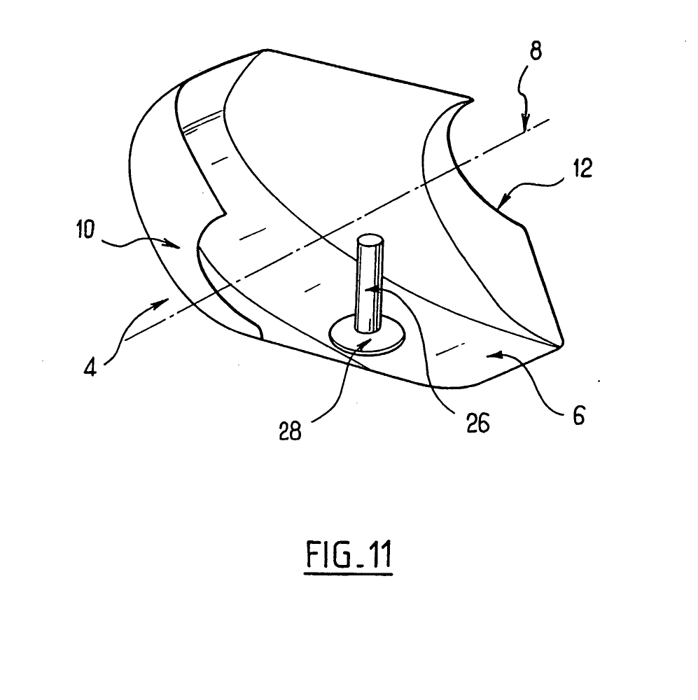

Another exemplary embodiment of a coating chamber is shown in FIGS. 10 and 11.

FIG. 10 shows the outside of the chamber 4. The chamber 4 comprises a substantially cylindrical peripheral wall 6 bent on one side of the wall 6 at the end wall 10, for example, and bent on another side of the wall 6 at the end wall 12. Two openings are made in the walls 10 and 12 to allow the passage of the drying means and of the means for bringing a coating solution into contact (means not shown in FIGS. 10 and 11) embodying an axis 8.

FIG. 11 shows the chamber 4 in section. In this figure the tube 26 and a shoe 28, the shape of which is a disk, are shown. However, any shape of shoe 28, such as one of those described in the previous developments, for example, could be adapted to the chamber 4 shown in FIGS. 10 and 11.

However, the invention could be implemented by means of a container other than a drum. It could, for example, be a fluidized bed apparatus, a Wurster tube apparatus or a vibrating fluidized bed.

The invention could be implemented by means of sugars such as sucrose, dextrose, fructose, maltose and glucose. It could be implemented by means of low-calorie sugar substitutes (sweeteners). It could be implemented by means of sugar alcohol and/or polyol compounds, such as for example maltitol or sorbitol. It could also be implemented by means of cellulose compounds.

What is claimed is:

1. A method of coating edible particles (30) in which, in a moving chamber (4):
the particles (30) are placed in contact with a coating solution, then,
the particles are placed in contact with the drying air,
characterized in that the drying air comprises less than 3.8 g of water per kilogram of air.

2. The method as claimed in claim 1, characterized in that the drying air comprises less than 3.5 g of water per kilogram of air.

3. The method as claimed in claim 1 or 2, characterized in that the drying air comprises less than 2.5 g of water per kilogram of air.

4. The method as claimed in any one of claims 1 to 3, characterized in that the drying air comprises less than 2 g of water per kilogram of air.

5. The method as claimed in any one of claims 1 to 4, characterized in that the drying air comprises less than 1 g of water per kilogram of air.

6. The method as claimed in any one of claims 1 to 5, characterized in that the drying air has a temperature between 15 and 85° C.

7. The method as claimed in any one of claims 1 to 6, characterized in that the drying air has a temperature between 20 and 40° C.

8. The method as claimed in any one of claims 1 to 7, characterized in that the coating solution comprises at least one sugar.

9. The method as claimed in claim 8, characterized in that the coating solution comprises sucrose.

10. An apparatus for coating edible particles, comprising:
a chamber (4) capable of being made to move;
means (42) for bringing a coating solution into contact with the particles (30) contained in the chamber; and
drying means (26, 24) for bringing the drying air into contact with the particles in the chamber,
characterized in that the drying means are capable of bringing the air comprising less than 3.8 g of water per kilogram of air into contact with the particles.

11. The apparatus as claimed in claim 10, characterized in that the drying means are capable of bringing the air comprising less than 3.5 g of water per kilogram of air into contact with the particles.

12. The apparatus as claimed in claim 10 or 11, characterized in that the drying means are capable of bringing the air comprising less than 2.5 g of water per kilogram of air into contact with the particles.

13. The apparatus as claimed in any one of claims 10 to 12, characterized in that the drying means are capable of bringing the air comprising less than 2 g of water per kilogram of air into contact with the particles.

14. The apparatus as claimed in any one of claims 10 to 13, characterized in that the drying means are capable of bringing the air comprising less than 1 g of water per kilogram of air into contact with the particles.

15. The apparatus as claimed in any one of claims 10 to 14, characterized in that the chamber (4) is mounted so that it can rotate about an axis (8), the apparatus comprising an air circulation duct (22) having a body (26) and an end part (28) perforated with orifices (39) capable of extending over the low part of the chamber.

16. The apparatus as claimed in claim 15, characterized in that the end part (28) is a shoe having, in a plane perpendicular to a direction radial to the axis (8), a cross section which is greater than the cross section of the body.

17. The apparatus as claimed in claim 15 or 16, characterized in that the shoe (28) has a width (1) parallel to the axis (8), which is greater than the width (d) of the body (26).

18. The apparatus as claimed in any one of claims 15 to 17, characterized in that the shoe (28) has a length (L) in a plane perpendicular to the axis (8) and substantially perpendicular to the radial direction, which is greater than the length (d) of the body (26).

19. The apparatus as claimed in any one of claims 15 to 18, characterized in that the body (26) is closer to the rear of the shoe (28) than to the front, with reference to a normal direction of rotation (41) of the chamber (4).

20. The apparatus as claimed in any one of claims 15 to 19, characterized in that the shoe (28) has a width (l), parallel to the axis (8), narrowing toward the front from the body (26) with reference to a normal direction of rotation (41) of the chamber.

21. The apparatus as claimed in any one of claims 15 to 20 characterized in that the shoe (28) has a width (l), parallel to the axis, narrowing in the direction of the body (26), from a region (32) of greater width.

22. The apparatus as claimed in any one of claims 15 to 21 characterized in that the shoe (28) has a width (l), parallel to the axis (8), narrowing in the direction away from the body (26), from a region of greater width (32).

23. The apparatus as claimed in any one of claims 15 to 22 characterized in that the duct (22) has a front flange (40) lying generally in a radial plane from the shoe (28) to the body (26).

24. The apparatus as claimed in claim 14, characterized in that the shoe has the overall shape of a disk having a large cross section lying in a plane perpendicular to the direction radial to the axis (8).

25. The apparatus as claimed in claim 14, characterized in that the shoe has the overall shape of a crescent, the longitudinal cross section of which falls within a radial plane of the body (26).

26. The apparatus as claimed in any one of claims 9 to 25, characterized in that the chamber (4) comprises a peripheral wall (6), two end walls (10, 12), and at least one deflector (14) extending from the peripheral wall.

27. The apparatus as claimed in claim 26, characterized in that the or each deflector (14) has a shape perpendicular, at least locally, to a direction radial to the axis (8).

28. The apparatus as claimed in either of claims 26 and 27, characterized in that the or each deflector (14) is flat.

29. The apparatus as claimed in any of claims 26 to 28, characterized in that the or each deflector (14) is contiguous with only one of the end walls (10, 12).

30. The apparatus as claimed in any one of claims 26 to 29, characterized in that the or each deflector (14) extends from a point of the peripheral wall (6) away from. one of the end walls, to another point of the other end wall away from the peripheral wall.

31. The apparatus as claimed in any of claims 26 to 30, characterized in that it comprises at least two deflectors (14).

32. The apparatus as claimed in claim 31, characterized in that the two deflectors (14) are flat and parallel.

33. The apparatus as claimed in any one of claims 26 to 32, characterized in that the peripheral wall (6) is cylindrical.

34. The apparatus as claimed in any one of claims 9 to 33, characterized in that at least one inner face of the chamber is covered with elastomer.

35. The method or apparatus as claimed in any one of claims 1 to 34, characterized in that the particles are food particles.

36. The method or apparatus as claimed in any one of claims 1 to 35, characterized in that the particles are confectionery particles.
